(19) United States
(12) Patent Application Publication
(10) Pub. No.: US 2007/0292835 A1
(43) Pub. Date: Dec. 20, 2007

(54) Method for reporting student relevant data

(76) Inventors: Clement Edwin Hartman, Whittier, CA (US); Matthew Ryan Hartman, Whittier, CA (US); Geoffrey Dean Hartman, Tarzana, CA (US)

Correspondence Address: NIXON PEABODY, LLP, 401 9TH STREET, NW, SUITE 900, WASHINGTON, DC, 20004-2128, US

(21) Appl. No.: 11/447,318

(22) Filed: Jun. 6, 2006

(51) Int. Cl. G09B 3/00

(52) U.S. Cl. 434/350

(57) ABSTRACT

A method for reporting student relevant data to parents that provides secure access by a validated user over a computer network to forms that enable the user to associate student relevant data categories with a particular student. The computer network enables selective display of the forms on a user's terminal. The method enables a user, e.g., teacher or administrator, to select a student and to associate student relevant data categories therewith. The method creates a message for each selected student corresponding to the associated student relevant data categories. The message is transmitted to parents; preferably in their language using prerecorded digital messages. Student relevant data comprises informational and behavioral data. The method preferably enables the user to select a set of students in one step and to concurrently associate student relevant data categories therewith. Messages sent by telephone to a parent are each preferably sent with different caller IDs.

### FIELD OF THE INVENTION

The present invention relates to methods of reporting student behavior, and in particular a method of reporting student relevant data including behavior to parents over a computer network.

### BACKGROUND OF THE INVENTION

The education system is currently struggling to provide a uniformly high quality of education to students. A significant problem is the lack of an effective means of involving parents in the daily educational experience of their children. Parents often both have full-time jobs, or are single parents, such that it is difficult to continuously interact with teachers and school administrators. As a result, student relevant data including the negative and positive behavior of the students in class, the completion of homework, attendance, general informational and other data may not become known to the parents in a timely manner. Consequently, parents are often not a position to help resolve their child's behavioral problems in a timely manner. What is needed therefore is a method that enables teachers and administrators to more easily report student relevant data to parents.

Similarly, teachers are often burdened with ever increasing student class loads, administrative duties, and paperwork. Consequently, teachers typically rarely contact parents to discuss problems which are developing, often due to the time and effort required to reach the parents. This leads to conflicts during progress report time when parents ask, “Why didn't I know about this sooner?” What is needed is method that enables teachers and administrators to inform parents more often and in a timely and meaningful way.

Additionally, language barriers and time conflicts that exist between teachers and parents further frustrate communication. Another drawback of various known automated systems that send phone calls to parents is that the voice on the call is not in the language of the parents. What is needed therefore is a method that transmits messages to parents in their language using prerecorded digital messages using voice, text, or other digital files. A further drawback is that a synthesized voice is used rather than a human voice. What is also needed is a method that uses human speakers in the language of the parents for prerecording digital voice messages for the plurality of student relevant data categories that may be reported to parents.

Typical known systems are focused primarily on sending general messages. A drawback of these known systems is that messages sent to the parents are not specific to each particular child/student. What is also needed is a method that enables the reporting of many types of student relevant data to the parents in one communication, e.g., a single telephone call including general broadcast information data and student specific data.

A known behavior reporting system and method is disclosed in commonly assigned U.S. patent application Ser. No. 11/046,497, incorporated by reference herein. One of the drawbacks of the method and system in that application is that it does not provide secure access by a validated user over a computer network to forms that enable the user to associate student relevant data categories with a particular student. The method described in that application does not provide a computer network that enables selective display of the forms on a user's terminal. Consequently, the method and system of that application does not provide the ease of use, power and robustness provided by a computer network accessed via a plurality of terminals. The method and system in that application has a drawback, for instance, of not providing for the use of computer network interface, e.g., a standard browser with a graphical user interface where the network is the Internet. Another drawback of method in that application is that it does not enable a user to select a set of students in one step and to concurrently associate student relevant data categories therewith. Consequently, that application's method and system requires substantially more teacher time since it requires student relevant data to be marked separately for each student, i.e., not currently for students selected in a group in one step. Teachers are extremely busy and may not have time to record all student relevant data for each student using the method in that commonly assigned application. A teacher may wish to request a conference call with the parents of a student. The method and system in that commonly assigned application has a drawback of not providing for allowing a teacher to make such a conference request via a form, resulting in extra time and effort to make the request in a more conventional way. Worse still, the teacher might forego requesting the conference due to the hassle of making the request using known methods.

The method and system of the above reference commonly assigned application and other known methods also have the drawback that a student may recognize the caller ID of a behavior reporting telephone calls to the parents and intercept the call in some manner. What is needed therefore is a method to help prevent interception by the student of reporting calls using caller ID information and other techniques.

### SUMMARY OF THE INVENTION

The present invention provides a method for reporting student relevant data to parents that provides secure access by a validated user over a computer network to forms that enable the user to associate student relevant data categories with a particular student.

Broadly stated, the present invention provides a method for reporting student relevant data to parents, the method comprising providing secure access by a validated user over a computer network to one or more forms available to the validated user via the computer network, the forms enabling the user to associate student relevant data categories with a particular student, the computer network including a plurality of terminals, the computer network enabling the selective display of the forms on the user's terminal; enabling the user via the forms to select a student and to associate one or more of the student relevant data categories with the student; creating a message for each the selected student corresponding to the student relevant data categories associated with the student; and transmitting the message to the parents of the student as a function of contact information for the parents.

An advantage of the present invention is that it providing secure access by a validated user over a computer network for reporting student relevant data including behavioral, informational data, and the like. A related advantage is that the present invention enables users to associate student relevant data with a particular student via one or more form on a computer network. According to one aspect, the present invention, in addition to enabling the sending of general school broadcast messages, enables student-specific messages to be sent therewith.

Another advantage of the present invention is that it preferably enables a user to select a set of students in one step and to concurrently associate one or more of said student relevant data categories with each student in that set.

Yet another advantage of the present invention is that preferably transmits messages to parents in their language using prerecorded digital messages. According to one aspect, the present invention has the advantage of enabling messages sent by telephone to a parent to be sent with different caller IDs to help avoid interception by a student. Another advantage of the present invention is that it enables a user to elect, via a form accessible on a computer network, that a conference request be sent to a particular student's parents.

These and other embodiments, features, aspects, and advantages of the invention will become better understood with regard to the following description, appended claims, and accompanying drawings.

### BRIEF DESCRIPTION OF THE DRAWINGS

The aforementioned and related advantages and features of the present invention will become apparent upon review of the following detailed description of the invention, taken in conjunction with the following drawings, where like numerals represent like elements, in which:

FIG. 1 is a block diagram of an exemplary system for illustrating the method according to the present invention;

FIG. 2 is an exemplary flow chart showing a process illustrating several aspects of the method according to the present invention;

FIG. 3 shows an exemplary login webpage wherein secure access is provided to a teacher or administrator user who provides log in validation;

FIG. 4 shows an exemplary teacher home page;

FIG. 5 shows an exemplary form for enabling a user via the form to select a student and to associate one or more of the student relevant data categories therewith;

FIG. 6 shows further details of the step in FIG. 2 for enabling the teacher or other user to select student relevant data including one or more behaviors for an individual student;

FIG. 7 shows an exemplary form displayed in response to selection of the corrective group in the form in FIG. 5 for selecting student relevant data wherein the data comprises corrective, negative behaviors;

FIG. 8 shows an exemplary form showing selectable student data categories displayed in response to selection of the Attendance group in the form in FIG. 5;

FIG. 9 shows an exemplary form showing selectable student data categories displayed in response to selection of the Informational group in the form in FIG. 5;

FIG. 10 shows an exemplary form showing selectable student data categories displayed in response to selection of the Grade progress group in the form in FIG. 5;

FIG. 11 shows an exemplary form showing selectable student data categories displayed in response to selection of the Rewarding/positive group in the form in FIG. 5;

FIG. 12 shows further details of the step in FIG. 2 for enabling a teacher or other user to select one or more student relevant data categories including behaviors for more than one student;

FIG. 13 shows an exemplary form displayed in response to selection of the Corrective group box in FIG. 5 to assign corrective behaviors to multiple students;

FIG. 14 shows an exemplary form wherein three students were selected and three student relevant data categories were selected on the form in FIG. 13 for reporting for the three students;

FIG. 15 shows further detail regarding the step in FIG. 2 for enabling a teacher to notify the entire class of one or more of certain student relevant data including general announcement behaviors and informative behaviors;

FIG. 16 shows an exemplary form to provide a menu of behaviors that can be reported for all students of a larger group, such as all in a class;

FIG. 17 shows an exemplary flow chart for a conference call request process for enabling the user to elect that a conference be requested; and

FIG. 18 shows a form that includes the conference call option that is preferably displayed after one or more behavior categories were selected and saved.

Reference symbols are used in the Figures to indicate certain components, aspects or features shown therein, with reference symbols common to more than one Figure indicating like components, aspects or features shown therein.

### DETAILED DESCRIPTION OF THE INVENTION

The method according to the present invention is for reporting student relevant data to parents. The student relevant data comprises behaviors, informational data, and other data in a plurality of individual student relevant data categories.

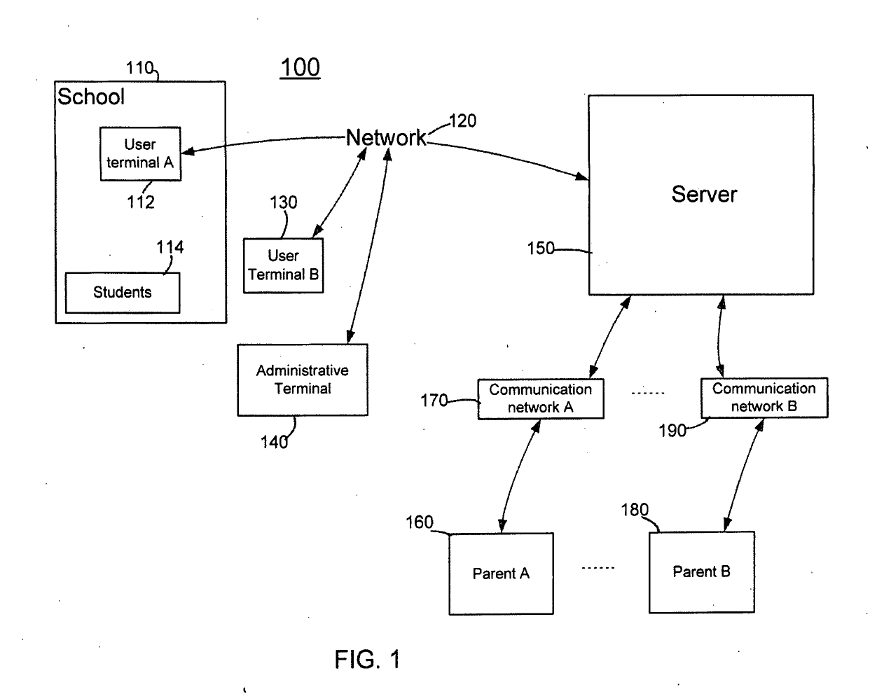

FIG. 1 is a block diagram of an exemplary system 100 for illustrating the method according to the present invention. The exemplary system 100 includes a school 110 having students 113. A user computer terminal A 114 is shown located in the school and connected to a server 150 via a computer network 120. A user computer terminal B 130 and an administrative terminal 140 are shown physically outside of the school 110 and both connected to server 150 via the computer network 120. The server 150 connects to a Parent A 160 via a communication network A 170. The server 150 connects to a Parent B 180 via a communication network B 190. The network connection between the terminals and server 150 may be wired or wireless. The terminals 112, 130, and 140 are preferably computing devices capable of accessing the server 150 over the network 120.

The server 150 as used herein represents a system for operating the processes of the method for providing student relevant data to parent according to the present invention. Preferably, the present invention provides an interface for users via an Internet website residing on a web server.

Preferably, the users for terminal A 112 and terminal B 130 may be teachers and administrators. The terminals also could be a portable computer device having wireless capability to access network 120 so it need not be within the confines of the school, e.g. terminal B 130. The administrative terminal 140 is alternatively used for providing student data to the server 150. Preferably, the student data is associated with a plurality of the teachers and the corresponding class periods. Alternatively, the student data comprises only a list of students and their contact information.

The method according to the present invention provides secured access over the computer network, e.g., computer network 120 seen in FIG. 1. The computer network 120 is preferably the Internet, although any suitable computer network for connecting terminals to the server 150 may be used. Where the computer network 120 is the Internet, for example, terminals 112, 130, and 140 preferably use a standard web browser to access a server website. The access to server 150 is secured such that users attempting access via the terminals 114, 130, or 140 must provide validation credential before being granted access to the server 150.

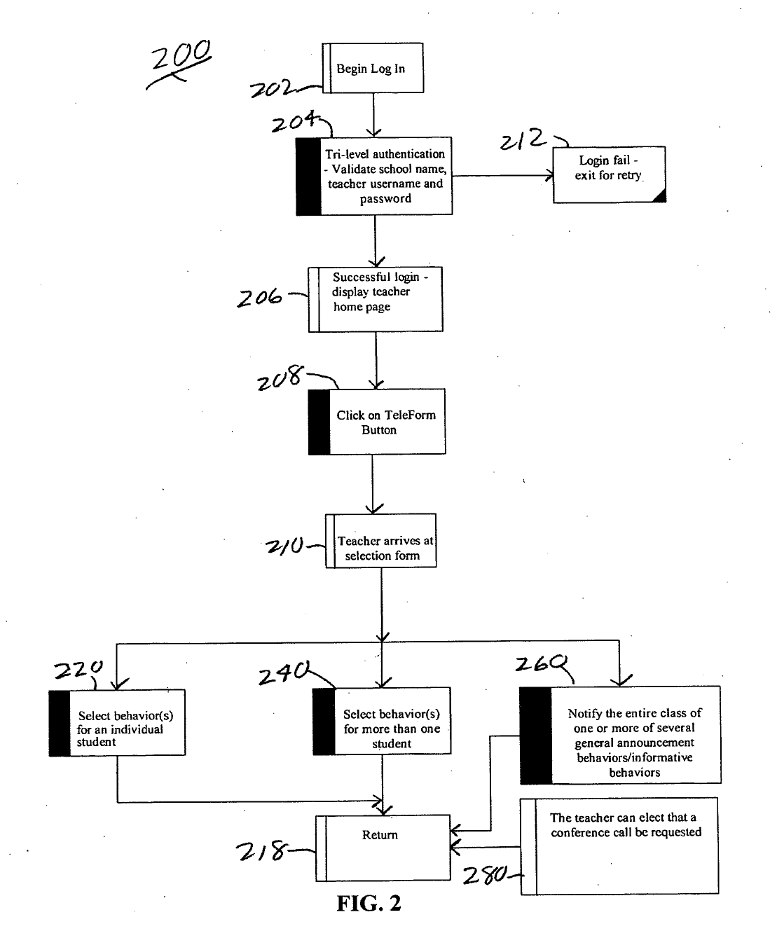

FIG. 2 is an exemplary flow chart showing a process 200 illustrating several aspects of the method according to the present invention. Although for convenience the user is often referred to as a teacher in the examples herein, other valid authorized users may also practice the present invention, i.e., the method is not limited to just teachers as users. Referring to FIG. 1; a teacher attempts access via a terminal such as teacher terminal A 112 and/or teacher terminal B 140. Numerous teachers and numerous corresponding terminals may have access at the same time. The network 120 in FIG. 1 is the Internet in the example shown in FIG. 2. It should be appreciated that the computer network according to the method of the present invention is not limited to the Internet. In addition, the process 200 in FIG. 2 describes exemplary web pages accessible via the Internet by validated users using a web browser, in the example. Although the method is described herein with respect to exemplary scenarios, it is not limited to those exemplary scenarios.

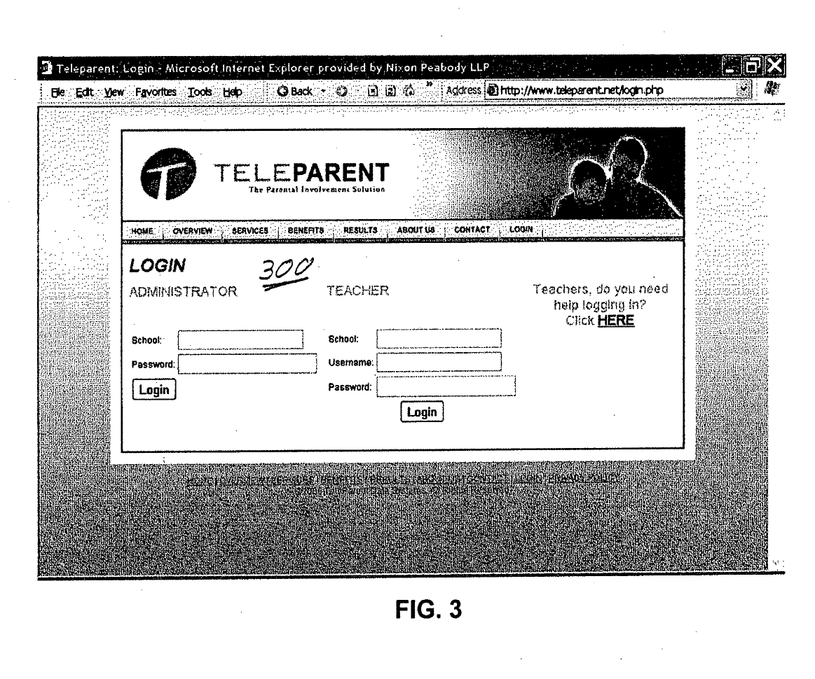

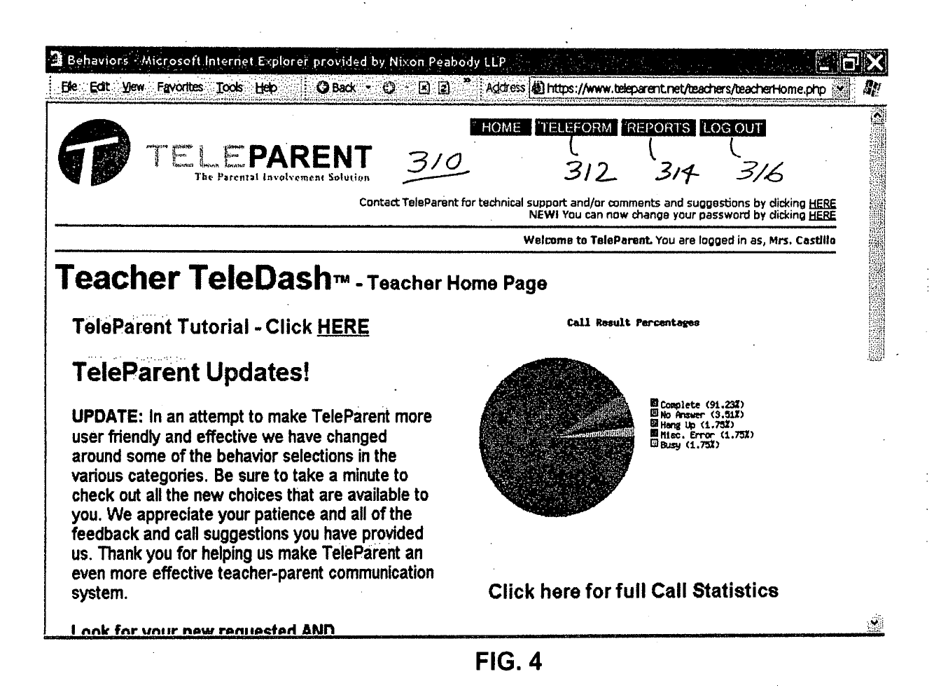

The method according to the present invention provides secure access to a validated user over a computer network. In Step 202, a login process begins for validating a user. FIG. 3 shows an exemplary login form 300 for validating a user. The form 300 in this example is displayed via a webpage at a website to which the user has directed web browser software on their terminal. In Step 204, the user is prompted to enter tri-level authentication comprising school name, username, and password, in this example. In Step 204, if the login fails, the process proceeds at Step 212 to preferably exit for retry, i.e., to enable the user to retry entry of the login authentication information. In Step 206, the teacher home page is displayed once there has been a successful login. FIG. 4 shows an exemplary teacher home page 310. Selectable buttons identified as teleform 312, reports 314, and a logout 316 in FIG. 4, are provided on home page 310 in this example.

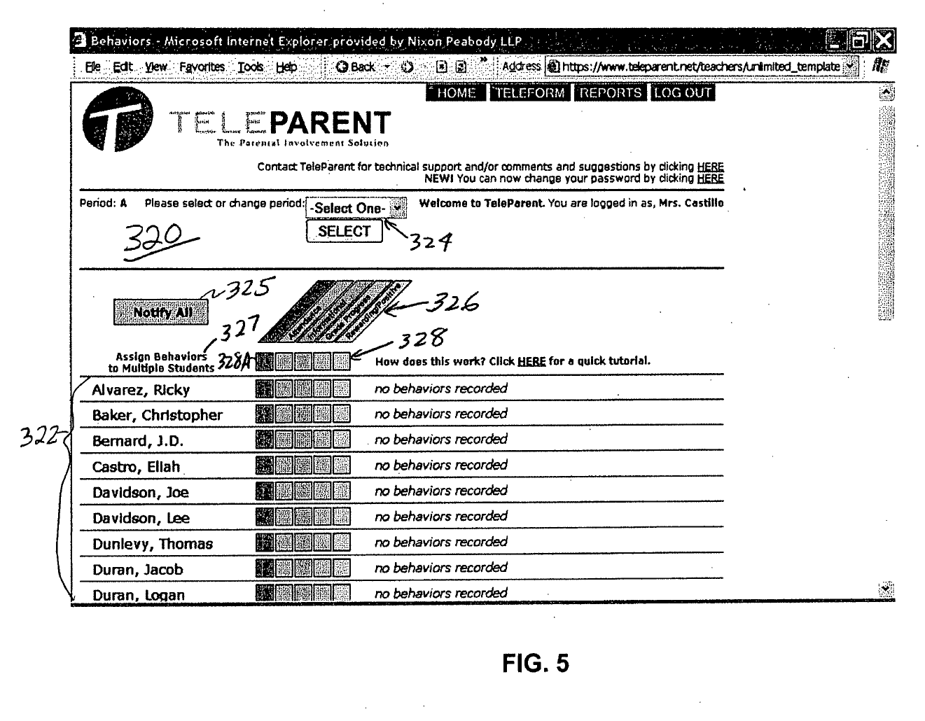

The method according to the present invention provides one or more forms to the validated user via the computer network 120. The forms enable the user to associate student relevant data categories with a particular student. The computer network 120 enables the selective display of the forms on the user's terminal, e.g., teacher terminal A, 112 in FIG. 1. In Step 208 in the example in FIG. 2, a click on the “teleform” button 402 enables display, in Step 210, of selection form 320 as shown in FIG. 5. It will be clear to one of ordinary skill in the art that for form 320 and other forms shown herein, the forms may comprise more than one display screen of the web pages in the examples; for convenience only portions of the forms are shown in some instances to illustrate the particular feature of the invention. It will also be clear to one ordinary skill in the art, that the forms shown and browser web display screen captures are exemplary, i.e., the forms may be displayed in other formats using other software for a suitable computer network terminal within the scope of the present invention.

The method enables a user via the forms to select a student and to associate one or more of the student relevant data categories with the student. Preferably, as shown in the exemplary form 320 in FIG. 5, a class roster 322 is shown for a class period A. Alternatively, only a roster of student is displayed without any class period designations. Preferably, the form enables the user to select a class period, using pull down menu 324. The roster 322 preferably comprises the group of students that a teacher has for a school period (i.e. period A, B, C, etc. or 1, 2, 3, etc.).

In the exemplary process 200 in FIG. 2, after Step 210, the process provides three options, Steps 220, Step 240, and Step 260, by which a user is enabled via the forms to make a student selection and to associate one or more of the student relevant data categories therewith. In Step 220, the method enables the teacher to select behavior(s) for an individual student. It should be appreciated that behavior(s) as used in FIG. 2 refers to student relevant data. Student relevant data may be grouped as into various behavioral or other groups.

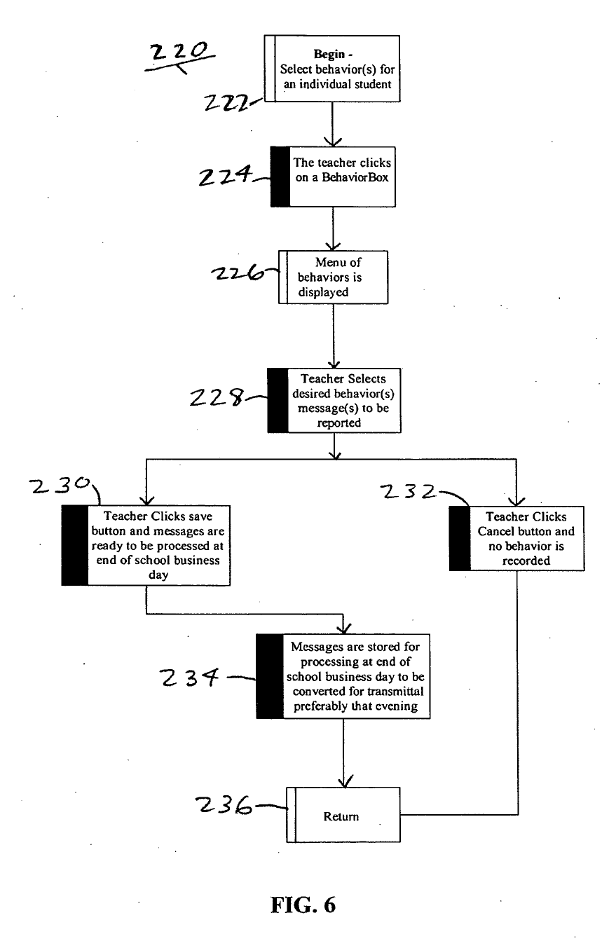

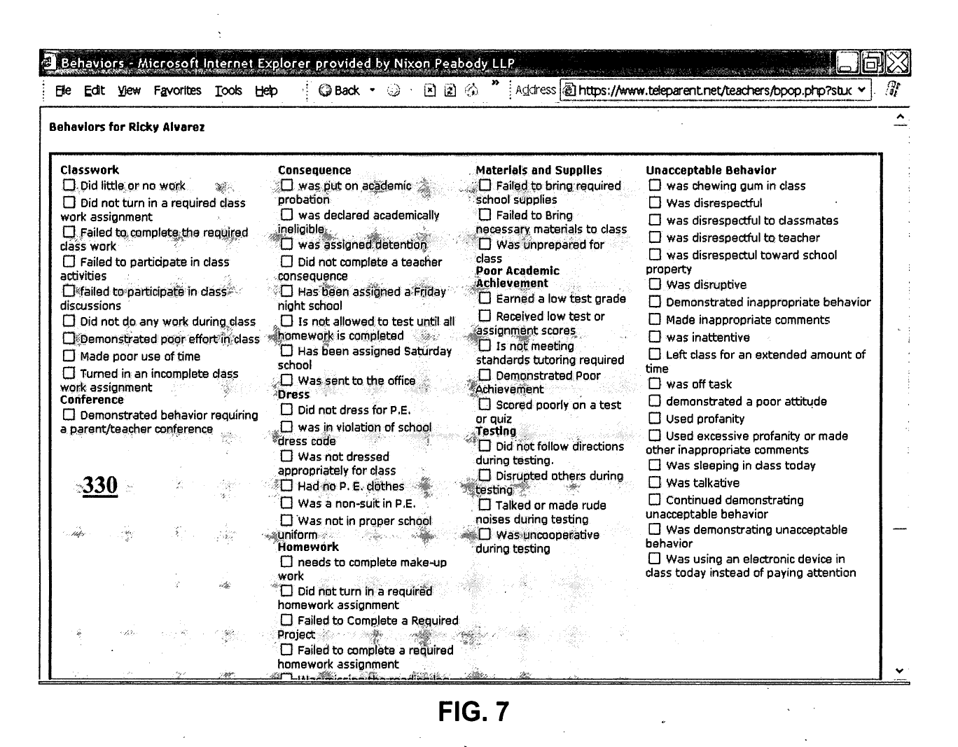

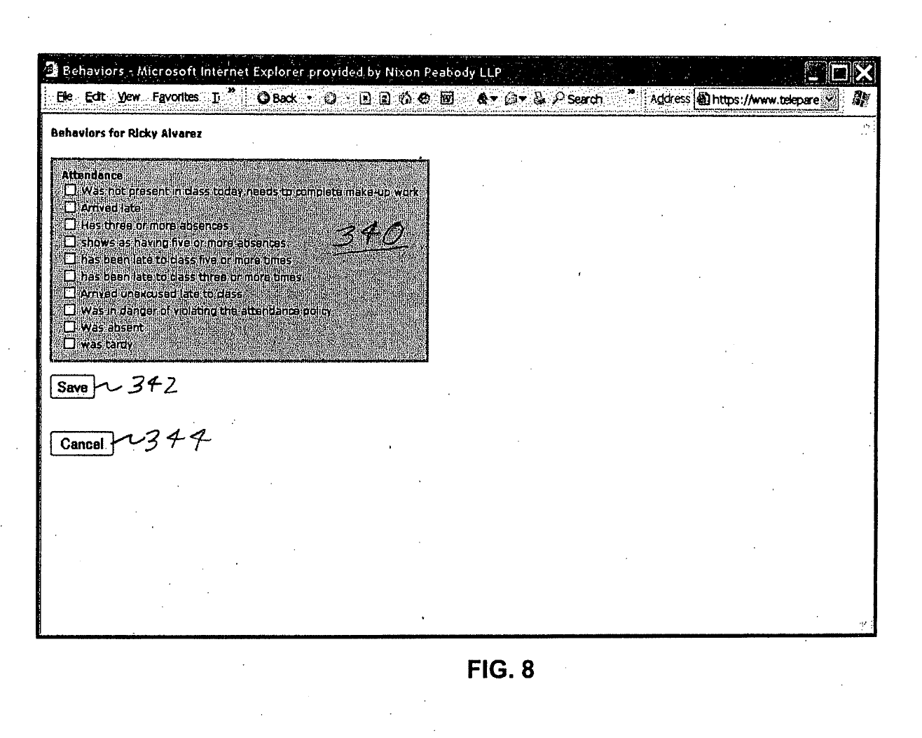

Exemplary Step 220 is shown in further detail in FIG. 6. Step 222 begins the process of selecting behavior(s) for individual students. In Step 224, the teacher clicks on a Behavior box, in this example. Referring to the exemplary form 320 in FIG. 5, Behavior box 326 preferably comprises the following groups: Corrective, Attendance, Informational, Grade Progress, Rewarding/Positive. The Behavior box 326 is preferably color coded by group for ease of use. Other suitable groups may be used. In Step 226, in response to one of the groups in the Behavior box, a menu of behaviors is displayed. For example, in response to selection of the Corrective group, a form 330 shown in FIG. 7 is displayed. FIG. 7 shows an exemplary form displayed in response to selection of the corrective group in the form in FIG. 5 for selecting student relevant data wherein the data comprises corrective, negative behaviors. The corrective group comprises negative behaviors. Form 330 shows the corrective behavior group for a student Ricky Alavarez broken into subgroups comprising classwork, consequence, homework, materials and supplies, poor academic achievement, testing, and unacceptable behavior. Each of the subgroups includes a plurality of selectable student relevant data categories shown with a corresponding adjacent box for selection. In Step 228, the teacher selects desired behavior(s) message(s) to be reported. In this example, a teacher/user wishing to report one or more of the Corrective student relevant data categories for Ricky Alvarez would select each appropriate box for the student relevant data categories on web page 330. After selecting in Step 228, the process can proceed to Step 230 or Step 232. At Step 232, in response to the teacher clicking a cancel button (e.g., 344 in FIG. 8), no behavior is recorded and the method proceeds to Step 236 where the process returns and proceeds to Step 218 in FIG. 2; wherein the user is returned to form 320 in FIG. 5.

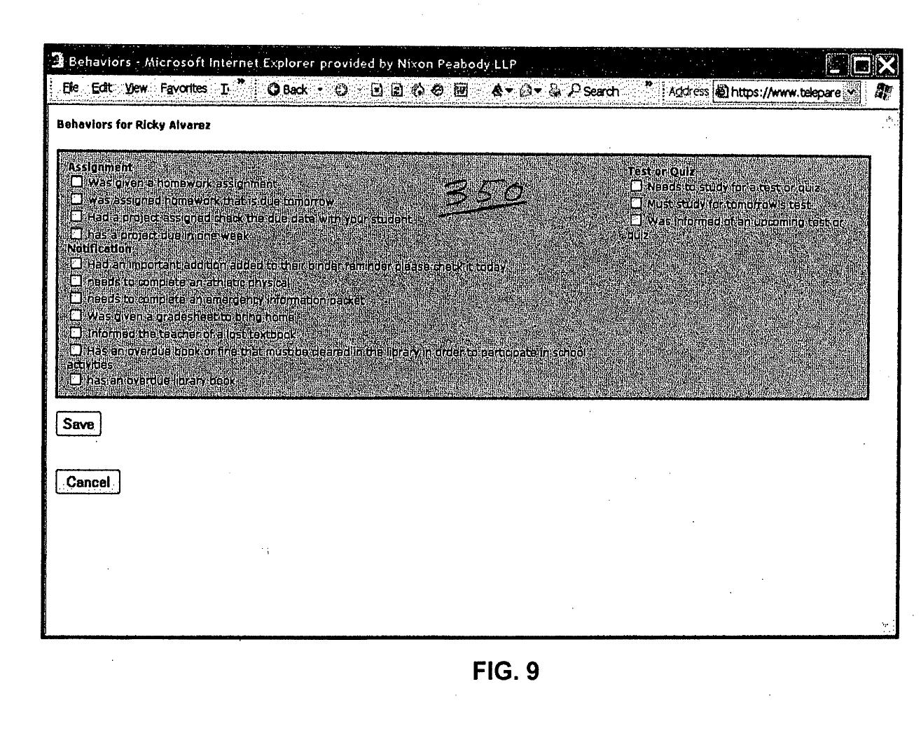

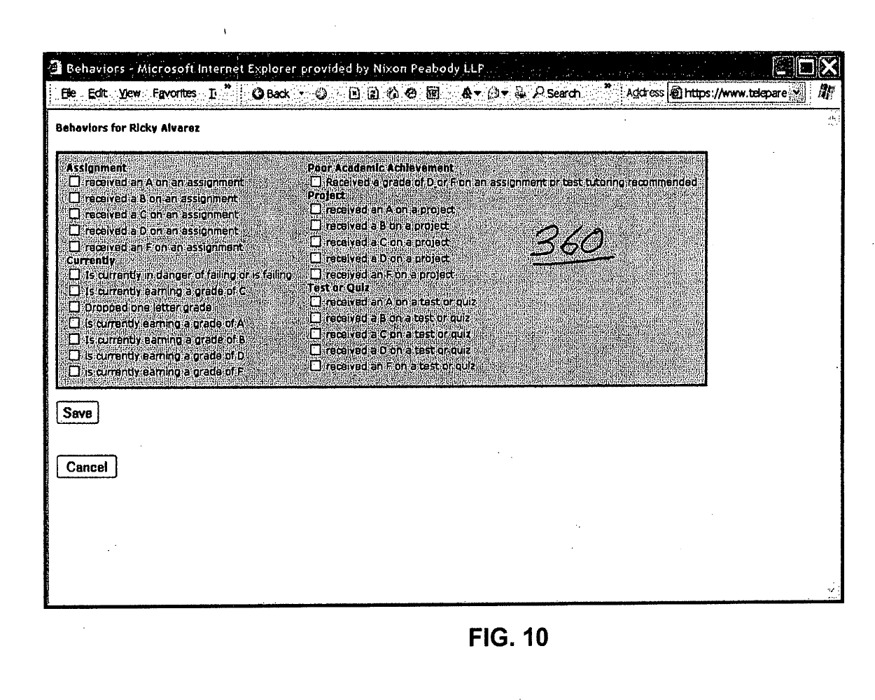

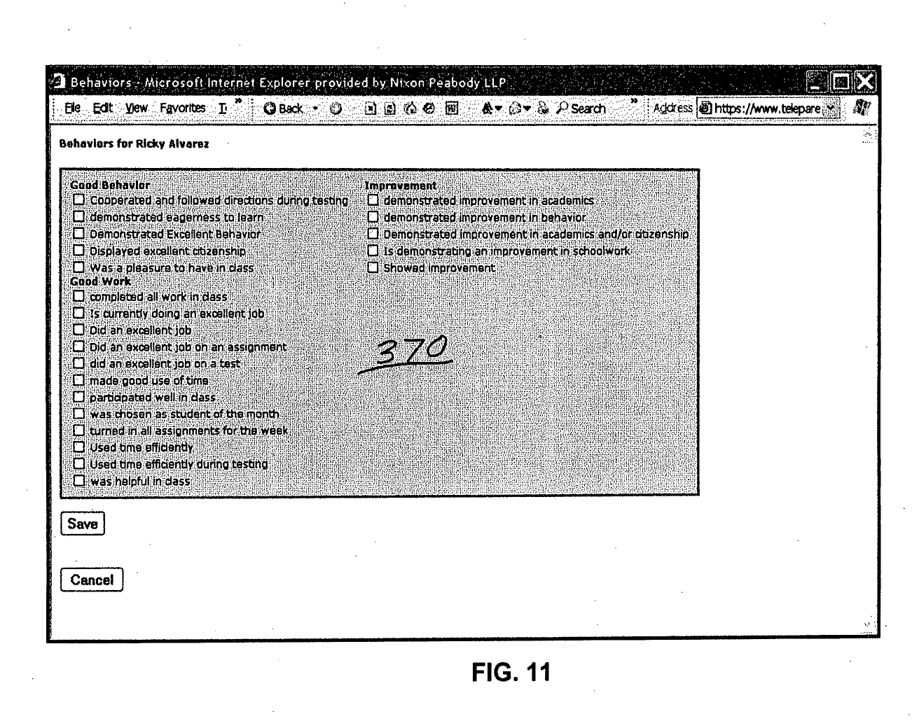

FIG. 8 shows an exemplary webpage form 340 showing selectable student data categories displayed in response to selection of the Attendance group in Behavior box 326 in FIG. 5. FIG. 9 shows an exemplary form 350 showing selectable student data categories in response to selection of the Informational group in Behavior box 326 in FIG. 5. FIG. 10 shows an exemplary form 360 showing selectable student data categories in response to selection of the Grade progress group in Behavior box 326 in FIG. 5. FIG. 11 shows an exemplary form 370 showing selectable student data categories in response to selection of the Rewarding/positive group in Behavior box 326 in FIG. 5.

Referring back to FIG. 2, in Step 230, after selecting is done at Step 228, in response to the teacher clicking a save button (e.g., 342 in FIG. 8), messages are made ready to be processed, preferably at the end of the school business day. In Step 234, messages are stored for processing at the end of the school business day to be converted for transmittal preferably that evening.

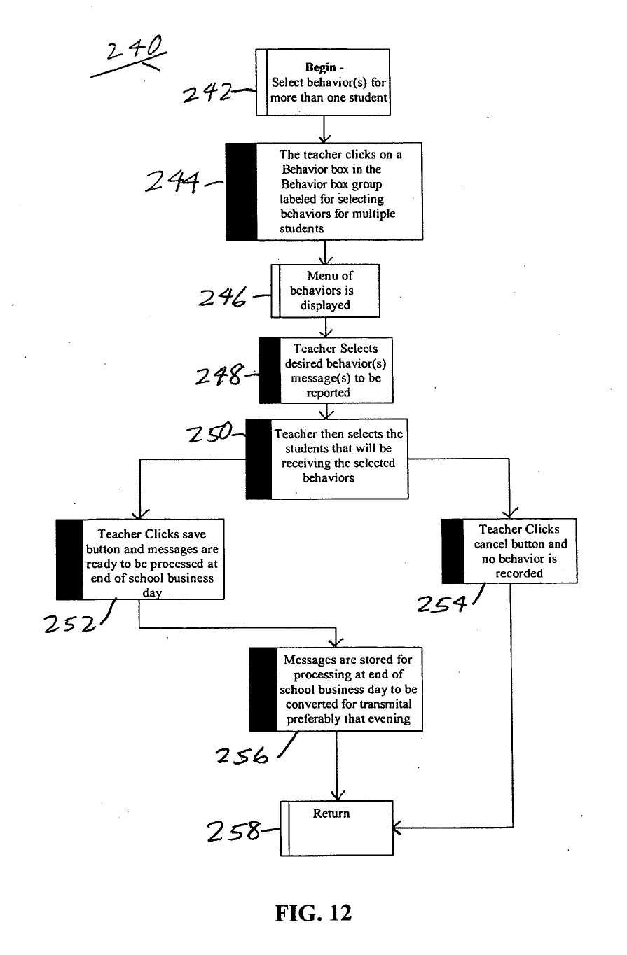

The method of the present invention preferably enables the teacher to select behavior(s) for more than one student. Further, the method preferably enables the user to select a set of students in one step and to concurrently associate one or more of the student relevant data categories with each student in the set. In Step 240 of the exemplary process 200 in FIG. 2, the teacher selects behavior(s) for more than one student. FIG. 12 shows further details of exemplary Step 240 in FIG. 2 for enabling a teacher or other user to select one or more student relevant data categories including behaviors for more than one student. Step 242 begins the process of selecting behavior(s) for more than one student. In Step 244, the teacher clicks on a Behavior box in the Behavior box group labeled for selecting behaviors for multiple students. The exemplary form 320 in FIG. 5 includes boxes 328 to assign behavior to multiple students, as shown next to label 327 positioned above the roster of student names 322. There is one of boxes 328 below, corresponding to, and preferably color coded for each of the Behavior box groups, in this example.

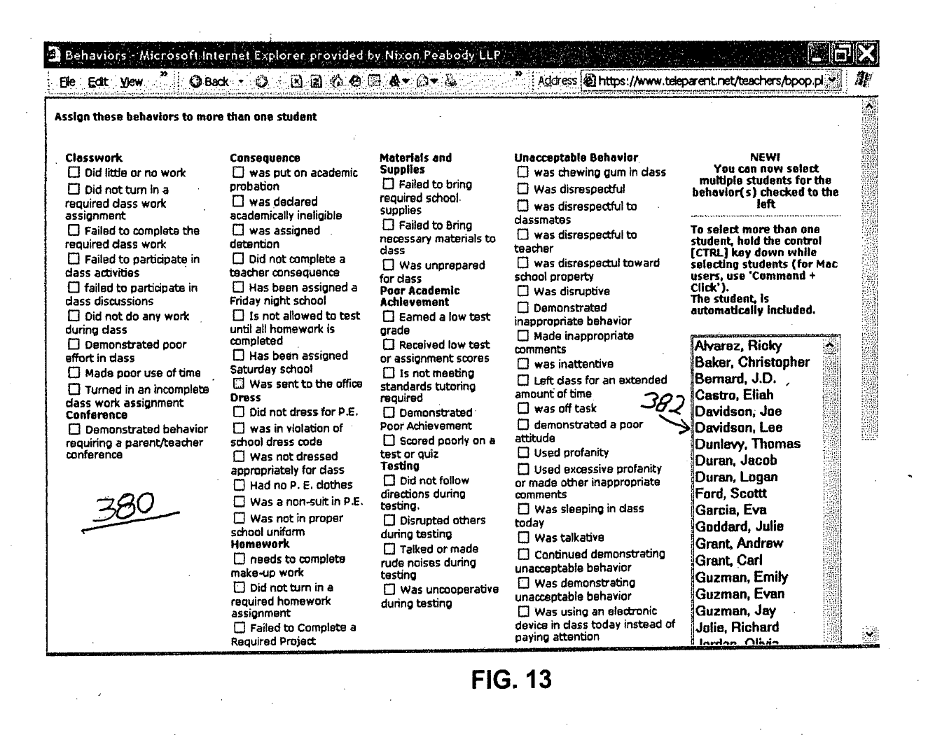

In Step 246, a form with a menu of the corresponding behaviors is displayed in response to the selection of Behavior box group for which to assign behaviors to multiple students. For example, in response to selection of the Corrective group box 328A to assign corrective behaviors to multiple students, a form 380 of the web page example shown in FIG. 13 is displayed. Form 380 shows student relevant data categories with corresponding adjacent boxes for selection. A list of students is shown at 382 in form 380. In Step 248 in FIG. 12, the teacher selects desired behavior(s) message(s) to be reported. In Step 250, the teacher then selects the student that will be receiving the selected behaviors, e.g., selected behavior student relevant data in a report to parents.

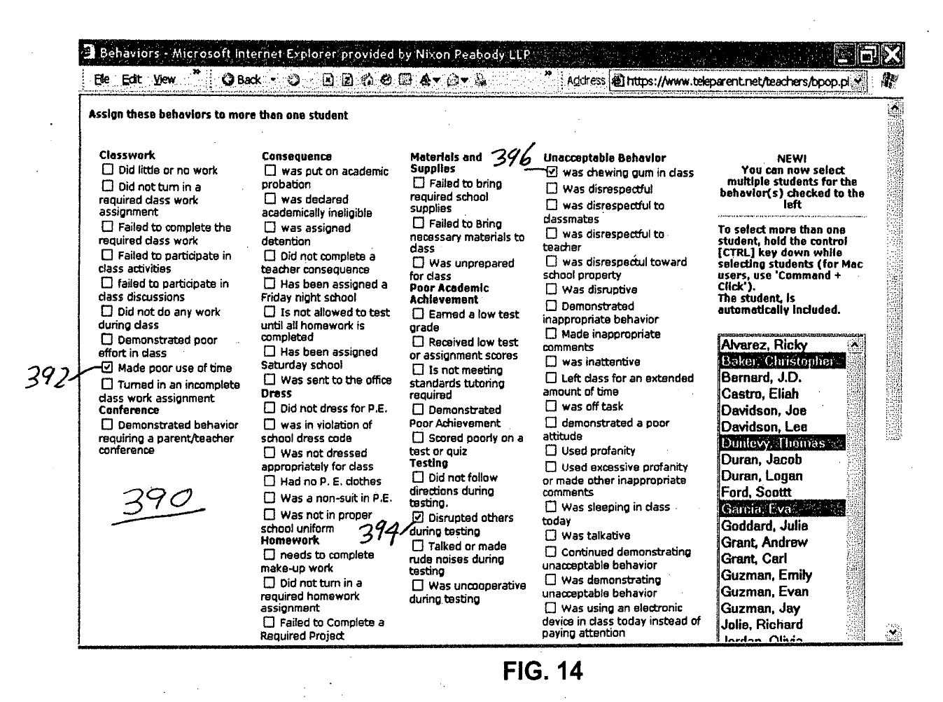

The method enables the user to select a set of students from the list 382 in one step and to concurrently associate one or more of the student relevant data categories in form 380 with each student in the set. According to one example, to select multiple students a teacher clicks on three students in the list while holding down the “Ctrl” key. FIG. 14 shows an exemplary form 390 wherein three students were selected and three student relevant data categories 392, 394, and 396 were selected on form 380 in FIG. 13 for reporting for the three students.

After selecting in Step 250, the process can proceed to Step 252 or Step 254. In Step 252, after selecting is done at Step 250, in response to the teacher clicking a save button (e.g., 342 in FIG. 8), messages are made ready to be processed, preferably at the end of the school business day. In Step 256, messages are stored for processing at the end of the school business day to be converted for transmitting preferably that evening. In Step 254, in response to the teacher clicking a cancel button (e.g., 344 in FIG. 8), no behavior is recorded. After Step 256 and after Step 254, the method proceeds to Step 258, where the process returns and proceeds to Step 218 in FIG. 2.

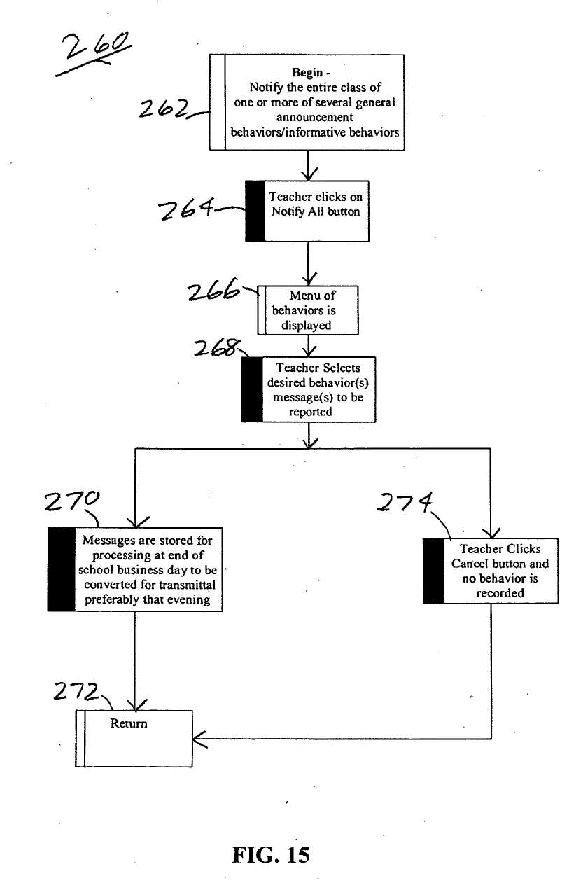

The method of the present invention according to a preferred embodiment provides a feature where a teacher or other user can select student relevant data categories for all students. It should be appreciated that the teacher or other user can preferably select all students in a class or alternatively select a group of student for the notification without any categorization by class; e.g. all student in a group, for a teacher, or in the school. FIG. 15 shows further detail regarding Step 260 in FIG. 2 for enabling a teacher to notify the entire class of one or more of certain student relevant data including general announcement behaviors and informative behaviors. In Step 262 begins the process of notifying. In Step 264, the teachers clicks a “notify all” button, in this example. The “notify all” button 325 is shown on form 320 in FIG. 5. It should be appreciated that the “notify all” button is merely an example of a way for the selection to be made, other ways can be used. In Step 266, in response to the selection of “notify all” in the example, a menu of behaviors is displayed.

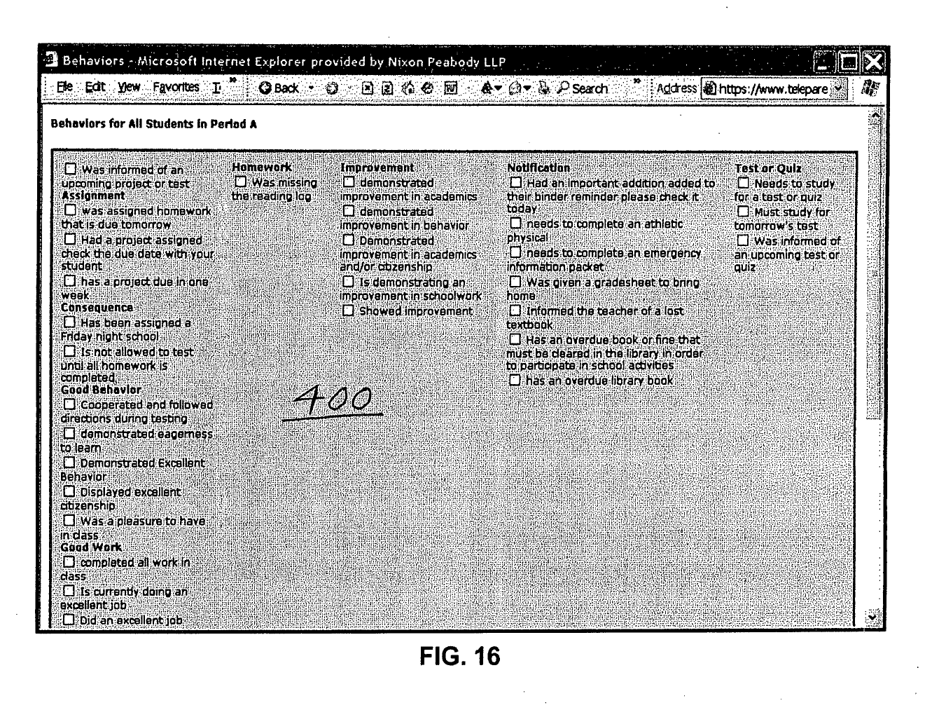

FIG. 16 shows an exemplary form 400 to provide a menu of behaviors that can be reported for all students, e.g., all students in a class. In Step 268, the teacher selects desired behaviors(s) from form 400 in FIG. 16 to be reported. In response to the teacher confirming the selections are to be saved, in Step 270, corresponding messages are stored for processing at the end of the school business day to be converted for transmitting preferably that evening; and the method proceeds to Step 272. In Step 272, the process returns and proceeds to Step 218 in FIG. 2. In Step 274, in response to the teacher clicking a cancel button (e.g., 344 in FIG. 8) indicating that selections in Step 268 are not be saved, no behavior is recorded and the method proceeds to Step 272.

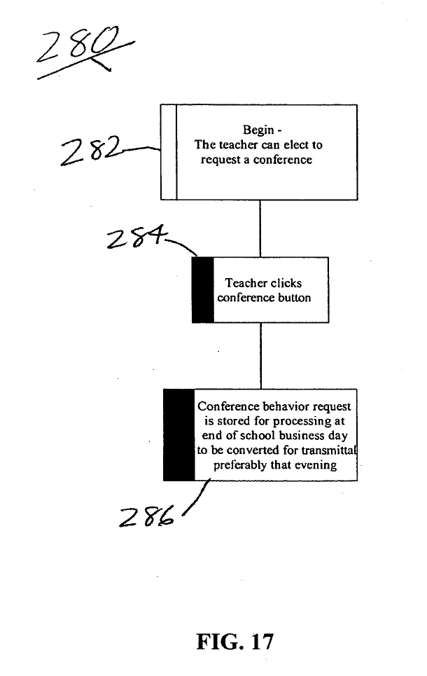

The method of the present invention according to a preferred embodiment includes enabling a user to elect that a conference be requested with a selected student's parents. In Step 280 in FIG. 2, the teacher can elect that a conference call be requested, in this example. Alternatively, the request can be for an in-person conference, video conference, or other mode of having a conference. FIG. 17 shows an exemplary flow chart for further details regarding the conference call request in Step 280 in FIG. 2. Step 282 begins the process wherein the teacher can elect to request a conference. Preferably, the method enables a conference call to be requested, via the conference button for example, after relevant student data has been selected and saved, e.g. in Steps 220, 240, or 260 in exemplary process 200 in FIG. 2.

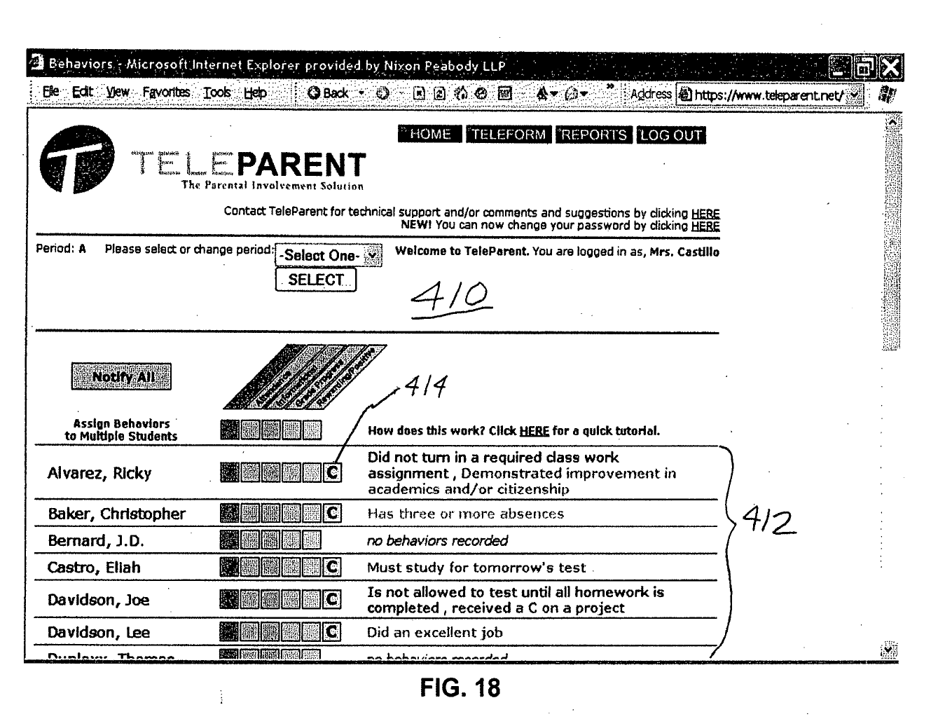

FIG. 18 shows a form 410 that includes the conference call option that is preferably displayed after one or more behavior categories were selected and saved. As seen in FIG. 18, form 410 lists the behaviors 412 that have been selected. The conference button “C” 414 is preferably displayed to enable election of a conference, i.e., to discuss the listed behavior and other student relevant data. The teacher can elect a conference be requested, as in the example in Step 282, wherein the teacher clicks a conference button. It should be appreciated that the election of a conference request can be made in other ways within the scope of the invention. In response, at Step 286, a conference behavior request is stored for processing at the end of the school business day to be converted for transmitting preferably that evening. Preferably, an indication is included for a student on form 410 where a conference has previously been elected for that student.

The method of the present invention creates a message for each selected student corresponding to the student relevant data categories associated with the student. The method of the present invention according to a preferred embodiment combines general broadcast messages from the school with student specific relevant data in one transmission to parents. The method also includes transmitting the message to the parents of the student as a function of their contact information. The contact information of the parents is preferably included with the student data obtained from administrative terminal 140 shown in FIG. 1 or another administrative computer. The student data, for example, may be stored in the Student Information System (SIS) developed for the Los Angeles Unified School District, the Schools Administrative Student Information (SASI) system from National Computer Systems in Mesa, Ariz., or the AERIES system from by Eagle Software in Santa Ana, Calif. residing in the administrative terminal 140. The administrate terminal 140 may be at a district office, at a specific school, or another suitable location.

The contact information preferably includes a contact language for the student's parents. The method according to a preferred embodiment includes forming the message to be sent to the parents in their contact language. Preferably formation of the message in the parent's language includes selecting a prerecording in that language of the associated student relevant data categories for the particular student. Selecting a prerecording includes mapping the corresponding student relevant with stored digital message files in a plurality of contact languages. The prerecording may be a digital audio file, digital text files, or other suitable digital file format.

Each of the student relevant categories is preferably prerecorded in a variety of languages including the contact languages of parents for students regarding which the method is practiced. A prerecorded audio message is preferably sent as a telephone call to each parent at a telephone number in the contact information. The contact information includes identifying information for the parents which may be phone numbers, e-mail addresses, instant message user names, and the like. Digital text files are preferably also in the language of the parents and may be transmit as email, text message, instant messages, faxes, messages to the parent's personal digital media center including via cable television, and the like. Parents may be provided with the ability to specify a preferred mode of transmission, a preferred phone number, the preferred e-mail address, or the like. The preferred mode is preferably via communication network, such as network A 170 and network B 190 shown in FIG. 1 for parent A 160 and Parent B 180, respectively. When text messaging is used, a condensed version of the student behavior may be preferred. When conventional phone calls are used for the transmission, a time period for calls is established. The transmission of student relevant data to parents 160, 180 in the example in FIG. 1, waits for the beginning of the time period, and then begins calling parents. At the end of the time period, calling is suspended. If a call fails to connect, a record is kept, the phone number is saved, and tried again later, preferably automatically at random times during the same calling period and preferably as many times as necessary to achieve success. Alternatively, failed calls are retransmit a preselected number of times.

The method of present invention according to a preferred embodiment, enables messages to be transmit on a more urgent basis, e.g., preferably in less than fifteen minutes, for messages to be sent in case of an emergency, e.g., a school lock-down, missing student, natural disaster, or the like. Preferably, other messages can preferably also be specified to be transmit immediately to parents, e.g., attendance related messages such as the “was absent” student relevant data category shown in FIG. 8.

According to a preferred embodiment, messages sent by telephone to a parent are each preferably sent with different caller IDs to help prevent interception by the student. Caller ID systems for this purpose are known to one skilled in the art. The telephone message is transmitted via one or more telephone calls to the parent's telephone number with a different caller for each said call. A record is created for any calls where said message is not completely received at the telephone of the parents.

The method preferably includes processing selected behavior categories to generate one or more reports. The reports, for example, may contain the behavior and other student relevant data of a specific student over a selected range of dates. The method preferably provides a report of student relevant data categories for a particular day selected for that day. Alternatively, the report shown categories for a day by class period. The reports may also be presented in a graphical form. For example, a bar chart (or histogram) with the horizontal axis representing behaviors and the vertical axis representing the number of occurrences. The method preferably enables a user to display reports on completed telephone calls and incompleted calls to parents. The calling reports may also be presented in a graphical form.

The invention has been described with regard to specific embodiments. Variations on these embodiments and other embodiments may be apparent to those of skill in the art. It is therefore intended that the invention not be limited by the discussion of specific embodiments. It is understood that the examples and embodiments described herein are for illustrative purposes only and that various modifications or changes in light thereof will be suggested to persons skilled in the art and are to be included within the spirit and purview of this application and scope of the appended claims.

1. A method for reporting student relevant data to parents, the method comprising:
providing secure access by a validated user over a computer network to one or more forms available to said validated user via said computer network, said forms enabling the user to associate one or more student relevant data categories with a particular student, said computer network including a plurality of terminals, said computer network enabling the selective display of said one or more forms on said user's terminal;
enabling said user via said one or more forms to select a student and to associate said one or more of said student relevant data categories with said student;
creating a message for each said selected student corresponding to said one or more student relevant data categories associated with said student; and
transmitting said message to said parents of said student as a function of contact information for said parents.

2. The method of claim 1, further comprising the step of enabling said user to select a set of students in one step and to concurrently associate said one or more of said student relevant data categories with each student in said set.

3. The method of claim 1, wherein a subset of said forms are organized by student, teacher, and class period, and said method enables said user via said subset to select a student and one of said student's class periods and to associate said one or more of said student relevant data categories with said student and said corresponding class period.

4. The method of claim 1, wherein said user is a teacher.

5. The method of claim 1, wherein said user is an administrator.

6. The method of claim 1, wherein said method enables said user to concurrently associate said one or more of said student relevant data categories with all of said students.

7. The method of claim 1, further comprising the step of enabling said user to select a student and request that a conference be requested with said student's parents.

8. The method of claim 1, wherein said one or more of said student relevant data categories include negative student behavior data, wherein said negative student behavior data is behavior to be corrected.

9. The method of claim 8, wherein said one or more of said student relevant data categories includes informational data applicable to all of said students, wherein said informational data is transmitted to all said student along with the particular student's student behavior data.

10. The method of claim 1, wherein said one or more student relevant data categories include student attendance.

11. The method of claim 1, wherein said one or more student relevant data categories include grade information.

12. The method of claim 1, wherein said one or more student relevant data categories include positive behavior information.

13. The method of claim 1, wherein said one or more student relevant data categories include test information.

14. The method of claim 1, wherein said contact information includes a contact language for said parents, and wherein said step of creating a message includes forming said message in said parent's contact language.

15. The method of claim 14, wherein forming said message includes selecting a prerecording in said parent's contact language of said one or more associated student relevant data categories for said selected student.

16. The method of claim 15, wherein said message is a digital audio message and said prerecording is a digital audio file.

17. The method of claim 14, wherein said message is a digital text message.

18. The method of claim 15, wherein selecting a prerecording includes mapping said one or more associated student relevant data categories with stored digital message files in said contact language.

19. The method of claim 1, wherein said contact information includes identifying information selected from the group consisting of phone numbers, e-mail addresses, and instant message user names.

20. The method of claim 1, further including the step of validating said user in response to receipt of more than one item of validating information from said user via said computer network.

21. The method of claim 1, further including obtaining data associating a plurality of said teachers, said students and said class periods from an administrative terminal.

22. The method of claim 1, wherein said network is in the Internet and said forms include one or more graphical user interfaces adapted for selective display using a web browser.

23. The method of claim 1, further comprising processing said one or more of said selected behavior categories to generate one or more reports and providing secure access by a validated user over a computer network to said one or more reports.

24. The method of claim 1, wherein said contact information includes a telephone number and said message is transmitted via a telephone call to said telephone number.

25. The method of claim 24, wherein said telephone call is sent at one or more times of day selected randomly within a selected time frame and said calls are transmitted automatically at said random times.

26. The method of claim 24, wherein said message is transmitted via one or more telephone calls to said telephone number with a different caller ID for each said call.

27. The method of claim 1, wherein a record is created for any messages where said message is not completely received by said parents.

28. The method of claim 1, wherein messages which are not completely received by said parents are retransmitted a preselected number of times.
